(19) United States
(12) Patent Application Publication
(10) Pub. No.: US 2023/0385898 A1
(43) Pub. Date: Nov. 30, 2023

(54) VEHICLE MATCHING METHOD AND VEHICLE MATCHING SERVICE PROVIDING SERVER

(71) Applicants: HYUNDAI MOTOR COMPANY, Seoul (KR); KIA CORPORATION, Seoul (KR)

(72) Inventors: Jeewook Huh, Seoul (KR); Dong Ho Yang, Incheon (KR); Hong Suk Kwak, Seoul (KR); Dong-Su Ha, Hwaseong-si (KR)

(73) Assignees: HYUNDAI MOTOR COMPANY, Seoul (KR); KIA CORPORATION, Seoul (KR)

(21) Appl. No.: 17/975,126

(22) Filed: Oct. 27, 2022

(30) Foreign Application Priority Data
May 27, 2022 (KR) 10-2022-0065280

(51) Int. Cl. G06Q 30/0601

(52) U.S. Cl. CPC G06Q 30/0631

(57) ABSTRACT

A vehicle matching method performed by a service providing server includes: receiving responses to a user question and a user propensity test from a user terminal and determining a user propensity based on the responses; calculating a plurality of vehicle propensities representing vehicle-specific characteristics; setting a plurality of option groups for each of the plurality of vehicles according to trim and option specifications of each vehicle; matching one option group among the plurality of option groups to the user based on the user propensity; determining a degree of matching between a vehicle propensity of each of a plurality of target vehicles belonging to a vehicle purchase budget range among the plurality of vehicles corresponding to the one option group and the user propensity; and determining at least one optimal vehicle among the plurality of target vehicles based on the degree of matching with the plurality of target vehicles.

### CROSS-REFERENCE TO RELATED APPLICATION

This application claims priority to and the benefit of Korean Patent Application No. 10-2022-0065280 filed in the Korean Intellectual Property Office on May 27, 2022, the entire contents of which are incorporated herein by reference.

### BACKGROUND

### (a) Technical Field

The present disclosure relates to a vehicle matching method and a service providing server for vehicle matching.

### (b) Description of the Related Art

As individuality is emphasized, propensity tests for individuals are being conducted in various forms. When the results of an individual's propensity test are used, it is possible to understand people's propensity in advance, so that social consensus may be improved.

In addition, when an individual decides on a career path or a company assigns work to an individual, in the past, quantitative indicators, such as grades or test scores, were mainly considered. However, in recent years, research is being conducted on methods that take individual propensities into account in various industrial fields because it is possible to predict a suitable career path in advance by using an individual propensity, or to strengthen corporate competitiveness by performing work that suits one's propensity.

The above information disclosed in this Background section is only for enhancement of understanding of the background of the disclosure. Therefore, this Background section may contain information that may not be considered as prior art that is already known to a person of ordinary skill in the art.

### SUMMARY

Embodiments of the present disclosure provide a method and a server for delivering optimal vehicle information by recommending a vehicle, a vehicle trim, and vehicle option specifications that match customer propensities. Further, the present disclosure takes into consideration not only the vehicle suitable for the customer, but also the trim and optional specifications of the vehicle, to provide a service that recommends a vehicle to be purchased by the customer.

Embodiments of the present disclosure provide a vehicle matching method performed by a service providing server. The vehicle matching method includes: providing a user question and a user propensity test to an application via a user terminal; receiving responses to the user question and the user propensity test from the user terminal; and determining a user propensity based on the responses. The method further includes: calculating a plurality of vehicle propensities representing vehicle-specific characteristics for each of a plurality of vehicles; setting a plurality of option groups for each of the plurality of vehicles according to trim and option specifications of each vehicle; matching one option group among the plurality of option groups to the user based on the user propensity; determining a degree of matching between a vehicle propensity of each of a plurality of target vehicles belonging to a vehicle purchase budget range among the plurality of vehicles corresponding to the one option group and the user propensity; and determining at least one optimal vehicle among the plurality of target vehicles based on the degree of matching with the plurality of target vehicles.

The matching may include: determining an option group that matches each of a plurality of vehicle propensity factors for each of the plurality of vehicles; determining an order of determining whether each of the plurality of option groups matches the user propensity; determining the user propensity as a score for each of a plurality of user propensity factors; and determining a ranking between the plurality of user propensity factors based on the score for each of the plurality of user propensity factors.

The vehicle matching method may further include, when a first ranking in an order of determining whether each of the plurality of option groups matches the user propensity is a first option group and the user propensity meets a condition of the first option group, matching the first option group to the user. The condition of the first option group may include a condition in which a predetermined number of propensity factors having a prior ranking among the rankings of the plurality of user propensity factors are factors matching the first option group and a difference in score between the factors matching the first option group and another factor is equal to or greater than a threshold value.

The vehicle matching method may further include, when a second ranking in the order of determining whether each of the plurality of option groups matches the user propensity is a second option group, the user propensity does not meet the condition of the first option group, and the user propensity meets a condition of the second option group, matching the second option group to the user. The condition of the second option group may include a condition in which a predetermined number of remaining propensity factors, not including the factors matching the first option group among the plurality of user propensity factors, having the prior ranking is the factors matching the second option group and a difference in score between the factors matching the second option group and the remaining propensity factors is equal to or greater than a threshold value.

The vehicle matching method may further include, when a third ranking in the order of determining whether each of the plurality of option groups and the user propensity match is a third option group, a fourth ranking is a fourth option group, the user propensity does not meet the conditions of the first and second option groups, and a score of the factor matching the third option group among the plurality of user propensity factors is higher than a score matching the fourth option group, matching the third option group to the user.

The determining of at least one optimal vehicle may include determining a predetermined number of vehicles having a prior ranking in an order of increasing the degree of matching among the plurality of target vehicles as the at least one optimal vehicle.

Embodiments of the present disclosure provide a service providing server including a processor coupled with a non-transitory memory storing program code. The service providing server includes: a collecting unit for collecting user information that is a response to a user question and a response to a user propensity test from a user terminal; a user propensity determining unit for determining a user propensity based on the user information and the response to the user propensity test; a vehicle propensity calculating unit for calculating a plurality of vehicle propensities representing vehicle-specific characteristics for each of a plurality of vehicles; an option group classifying unit for setting a plurality of option groups for each of the plurality of vehicles according to trim and option specifications of each vehicle; an option group matching unit for determining a target option group to match a user based on the user propensities and the plurality of vehicle propensities among the plurality of option group; and an optimal vehicle determining unit for determining a plurality of target vehicles corresponding to the target option group among the plurality of vehicles and corresponding to a vehicle purchase budget range of the user and for determining at least one optimal vehicle among the plurality of target vehicles according to a degree of matching in which each of the plurality of target vehicles matches the user propensity.

The option group matching unit may determine an option group matching each of a plurality of vehicle propensity factors for each of the plurality of vehicles among the plurality of option groups, determine an order between the plurality of option groups, determine the user propensity as a score for each of a plurality of user propensity factors, and determine a ranking between the plurality of user propensity factors based on the score for each of the plurality of user propensity factors.

When a first ranking in the order between the option groups is a first option group, a predetermined number of propensity factors having a prior ranking among the plurality of user propensity factors are factors matching the first option group, and a difference in a score between the factors matching the first option group and another factor is equal to or greater than a threshold value, the option group matching unit may match the first option group to the user.

When a second ranking in the order between the option groups is a second option group, the user does not match the first option group among the plurality of user propensity factors, a predetermined number of remaining propensity factors, not including the factors matching the first option group among the plurality of user propensity factors, having a prior ranking is the factors matching the second option group, and when a difference in score between the factors matching the second option group and the remaining propensity factors is equal to or greater than a threshold value, the option group matching unit may match the second option group to the user.

When a third ranking in the order between the option groups is a third option group and a fourth ranking is a fourth option group, the first or second option group does not match the user, and a score of a factor matching the third option group among the plurality of user propensity factors is higher than a score matching the fourth option group, the option group matching unit may match the third option group to the user.

The optimal vehicle determining unit may calculate the degree of matching according to a result of comparing the user propensity with the plurality of vehicle propensities for each of the plurality of target vehicles, assign a matching order to each of the plurality of target vehicles in an order of increasing the degree of matching, and determine a predetermined number of vehicles with a prior ranking as the at least one optimal vehicle according to the matching order.

According to the present disclosure, it is possible to improve satisfaction of a user receiving a service by providing a propensity test to the user, determining a user propensity based on a result of the propensity test, determining a propensity of a vehicle based on vehicle data, classifying a plurality of vehicles by trim and option specifications, determining the vehicle, vehicle trim, and option specifications that match the user propensity from a result of the classification, and delivering information about an optimal vehicle suitable for the user to purchase to the user.

### BRIEF DESCRIPTION OF THE DRAWINGS

FIG. 1 is a block diagram schematically illustrating a vehicle matching system that provides a vehicle purchase information service according to an embodiment.

FIG. 2 is a flowchart of a vehicle matching method according to an embodiment.

FIG. 3 is a detailed flowchart of operation S6 of FIG. 2.

FIG. 4 is a detailed flowchart of operation S602 of FIG. 3.

### DETAILED DESCRIPTION

Hereinafter, embodiments of the present specification are described in detail with reference to the accompanying drawings. The same or similar constituent factors or elements are denoted by the same reference numerals regardless of a reference numeral, and a repeated description thereof is omitted. Suffixes, “module” and and/or “unit” for constituent factors are used for the description below and are given or mixed in consideration of easiness of the writing of the specification. Each particular suffix itself does not have a discriminated meaning or role. Further, detailed descriptions relating to well-known functions or configurations are omitted when the detailed descriptions may make the subject matter of the disclosed embodiment unnecessarily ambiguous. Further, the accompanying drawings are provided for helping to easily understand various embodiments disclosed in the present specification. The technical spirit and features disclosed in the present specification are not limited by the accompanying drawings or by the disclosed embodiments. It should be appreciated that the present disclosure includes all of the modifications, equivalent matters, and substitutes included in the spirit and the technical scope of the present disclosure.

Terms including an ordinary number, such as first and second, are used for describing various constituent factors or elements, but the constituent factors are not limited by the terms. The terms are used only to differentiate one constituent factor from another constituent factor.

It should be understood that when one constituent factor or element is referred to as being “coupled to”, “coupled with”, or “connected to” another constituent factor or element, one constituent factor or element can be directly coupled to, coupled with, or connected to the other constituent factor, but intervening factors or elements may also be present. By contrast, when one constituent factor is referred to as being “directly coupled to”, “directly coupled with”, or “directly connected to” another constituent factor or element, it should be understood that there are no intervening factors.

In the present application, it should be appreciated that terms “including” and “having” are intended to designate the existence of characteristics, numbers, steps, operations, constituent factors, and components described in the specification or a combination thereof, and do not exclude a possibility of the existence or addition of one or more other characteristics, numbers, steps, operations, constituent factors, and components, or a combination thereof in advance.

In addition, the terms “-er”, “-or”, and “module” described in the specification mean units for processing at least one function and operation, and can be implemented by hardware components or software components, and combinations thereof.

In the specification, user propensity may include personal propensities that may be considered when a user purchases a vehicle among various personal propensities. Each of these personal propensities is referred to as a user propensity factor. In the specification, a vehicle propensity may include a qualitative characteristic of a vehicle corresponding to the user propensity. A user refers to a customer who wants to receive a vehicle recommendation using a vehicle purchase information service according to an embodiment of the present disclosure.

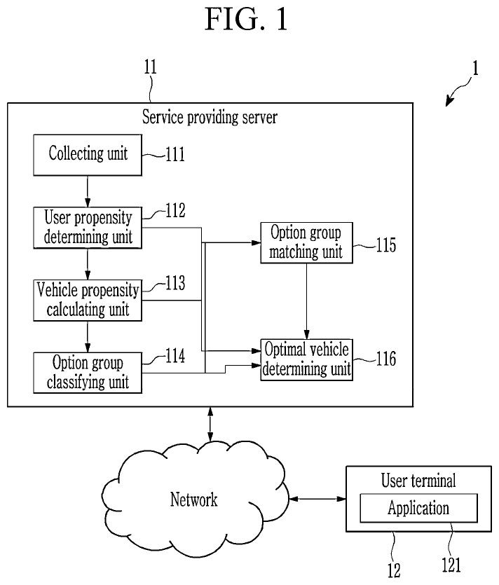

FIG. 1 is a block diagram schematically illustrating a vehicle matching system that provides a vehicle purchase information service according to an embodiment.

Hereinafter, the vehicle purchase information service may include a service that provides a user terminal with information on a vehicle that a user can purchase via an application.

The vehicle matching system 1 may include a service providing server 11 and a user terminal 12. Each component is connected to each other via a network. An application 121 is installed in the user terminal 12. One of ordinary skill in the art should appreciate that the service providing server 11, the one or more units of the service providing server, and the application 121 may be implemented as specially configured hardware or one or more processors and/or a combination of the aforementioned capable of executing program codes or computer-executable instructions (e.g., executable software code, firmware code, and the like) stored in one or more associated non-transitory memories or non-transitory computer-readable medium. The one or more processors may be programmed to perform the noted purpose, operation, or function. The application 121 may be a part of the service providing server 11 or may be a separate component. Further, in one embodiment, the service providing server 11 may cause the application 121 and the one or more units to perform computer-executable instructions stored in the associated non-transitory memory.

The service providing server 11 may provide the user with the vehicle purchase information service according to user information received from the user terminal 12 and a response to a user propensity test. The user information is information necessary for the service providing server 11 to provide the vehicle purchase information service. Further, the user information may be information necessary to reduce the number of categories of the vehicle. For example, the user information may include information about the user's vehicle purchase budget, the number of people to ride in the vehicle, the user's age, the use of the vehicle, the traveling distance of the vehicle per unit period, the time of sale of a used car, and the like. A user question refers to a question to obtain user information.

The user propensity test may include a question required for the service providing server 11 to determine the user's propensity for vehicle purchase (hereinafter, user propensity). The application 121 may receive the user propensity test from the service providing server 11 via the user terminal 12. When the user responds to the user propensity test, the application 121 may transmit a user's response to the service providing server 11 via the user terminal 12.

A non-transitory signal received from the service providing server 11 to the user terminal 12 is processed as information by an application processor (“AP”) of the user terminal 12. The AP may transmit the corresponding information to the application 121 according to an embodiment. The application 121 may perform a calculation based on the information received from the AP. Further, the application 121 may display the result of the performed calculation on the user terminal 12 or transmit the result of the performed calculation to the service providing server 11 through/via the user terminal 12. For example, the application 121 according to an embodiment may be operated to perform a determination according to information received from the service providing server 11 through/via the user terminal 12 and display the determination result on the user terminal 12. Further, the application 121 may process information based on the input from the user terminal 12 and transmit the processed information to the service providing server 11 through/via the user terminal 12.

The service providing server 11 includes a collecting unit 111, a user propensity determining unit 112, a vehicle propensity calculating unit 113, an option group classifying unit 114, an option group matching unit 115, and an optimal vehicle determining unit 116. The collecting unit 111, the user propensity determining unit 112, the vehicle propensity calculating unit 113, the option group classifying unit 114, the option group matching unit 115, and the optimal vehicle determining unit 116 may be implemented by one or more specifically configured processors coupled with one or more non-transitory memories storing computer-executable instructions.

The collecting unit 111 transmits user questions and a user propensity test including questions for determining a user propensity to the user terminal 12. The collecting unit 11 further collects user information and responses to the user propensity test (hereinafter, a user propensity response) received from the user terminal 12. The collecting unit 111 may store the collected user information and user propensity responses in a database.

The user propensity determining unit 112 may determine the user propensity based on the user propensity response collected by the collecting unit 111.

The vehicle propensity calculating unit 113 may calculate a vehicle propensity (hereinafter, vehicle propensity) based on a plurality of vehicle data. The plurality of vehicle data may be data indicating the appearance and performance of the vehicle, such as specifications, price, and color of the vehicle. The plurality of vehicle data may be stored in a database or collected from a server operated by a vehicle manufacturer. Hereinafter, when there is a plurality of types of power trains applied to one vehicle, it is assumed that each of the plurality of power trains constitutes a separate vehicle. For example, the ELANTRA 1.6 gasoline and the ELANTRA N-line may be divided as different vehicles.

The option group classifying unit 114 may set a plurality of option groups for each of the plurality of vehicles according to the trim and option specifications of each vehicle. The option specification indicates a specification excluding a specification serving as a criterion for vehicle selection among a plurality of vehicle specifications. The specification that is the criterion for selecting a vehicle may include a powertrain. The option specifications may include a specification related to driving safety, a specification related to the exterior and interior of the vehicle, a seat of the vehicle, a convenience specification for improving driving convenience, and use related to infotainment.

The option group matching unit 115 may determine at least one option group (hereinafter, referred to as a target option group) to be matching the user based on the user propensity, the plurality of vehicle propensities, and data representing the plurality of option groups. The option group matching unit 115 may transmit data indicating the determined target option group to the optimal vehicle determining unit 116.

The optimal vehicle determining unit 116 may determine vehicles (hereinafter, a plurality of target vehicles) belonging to the target option group among the plurality of vehicles and belonging to a user's vehicle purchase budget range based on the user information, the user propensity, the vehicle propensity for the plurality of vehicles, and the target option group, and sort the plurality of target vehicles in the order of the greatest degree of matching with the user's propensity (hereinafter, the matching degree). The optimal vehicle determining unit 116 may rank each of the plurality of target vehicles in an order of increasing degree of matching (hereinafter, referred to as a matching order). The optimal vehicle determining unit 116 may determine at least one vehicle to be presented to the user terminal 12 (hereinafter, referred to as an optimal vehicle, or at least one optimal vehicle) among the plurality of target vehicles. The, or the at least one, optimal vehicle is a predetermined number of vehicles whose matching order is a prior order among a plurality of target vehicles determined by the optimal vehicle determining unit 116. The optimal vehicle determining unit 116 may present the determined optimal vehicle data to the user terminal 12.

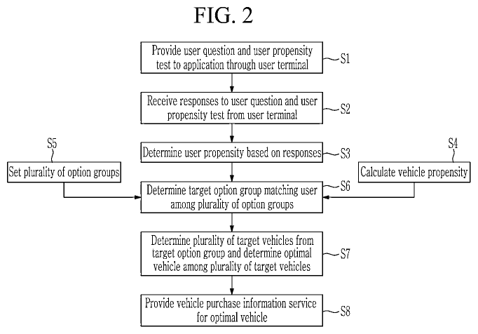

The operation of each configuration of the vehicle matching system 1 is described below with reference to FIGS. 2-4.

FIG. 2 is a flowchart of a vehicle matching method according to an embodiment.

The collecting unit 111 may provide a user question and a user propensity test to the application 121 through/via the user terminal 12 (51). The application 121 provided with the user question and the user propensity test may receive responses to the user question and the user propensity test from the user through/via the user terminal 12. For example, a user who wants to purchase a vehicle may input the response to the user question and the user propensity test to the user terminal 12.

The collecting unit 111 may receive the responses to the user question and the user propensity test from the user terminal 12 (S2). The collecting unit 111 may transmit the received response to the user propensity determining unit 112.

The user propensity determining unit 112 may determine a user propensity based on the responses to the user question and the user propensity test (S3). The user propensity determining unit 112 may determine the user propensity by analyzing the responses to the user question and the user propensity test. The user question may include questions about the user's vehicle purchase budget, the number of people to ride in the vehicle, the user's age, the use of the vehicle (e.g., intended use of the vehicle), a traveling distance of the vehicle per unit period (e.g., expected traveling distance), and the like. The user propensity test may include questions required for the service providing server 11 to determine the user propensity. For example, the user propensity test may include a question such as “what is your favorite travel destination between a resort or a tourist spot?”

The user propensity may be determined by a plurality of user propensity factors. The plurality of user propensity factors may include economic feasibility, which indicates the degree of interest of the user in the price of the vehicle, safety, which indicates the degree of interest of the user to the vehicle's defenses against external dangers or accidents, self-consciousness, which indicates the degree of interest of the user in the evaluation on the user of other users, technology, which indicates the degree of interest of the user in new technologies applied to vehicles, reliability, which indicates the degree of interest of the user in the quality evaluation of the vehicle, functionality, which indicates the degree of interest of the user in the performance of the vehicle, and aesthetics, which indicates the degree of interest of the user in the vehicle's design. It may be determined that the higher the self-consciousness, the greater the user's desire to show off through the vehicle. However, the plurality of user propensities is not limited to the contents listed above. In other words, various factors that may be considered in determining the user propensity may be further considered in determining the user propensity. The user propensity test may not include a question to directly ask a user propensity, but may include a question for judging a user's value indirectly related to the user propensity.

The user propensity determining unit 112 may calculate a plurality of weights for the plurality of user propensity factors based on the response to the user propensity test and determine the user propensity based on the plurality of calculated weights. In addition, the user propensity determining unit 112 may perform a clustering operation of classifying a plurality of users into a predetermined number of groups indicating user propensities (hereinafter, user propensity groups) in determining the user propensity. The user propensity determining unit 112 may set a plurality of user propensity groups based on the weight distribution for each user propensity factor. Further, the user propensity determining 112 may perform a clustering operation of determining the user propensity by matching the weight distribution for each user propensity factor based on the response to the user propensity test for each user and a similar group among the plurality of user propensity groups.

In order to determine the plurality of user propensity groups, the user propensity determining unit 112 may accumulate the responses to the user propensity test. Further, when the accumulated data is equal to or greater than a predetermined size, the user propensity determining unit 112 may apply clustering to the accumulated data. The number N of the plurality of user propensity groups (N is a natural number) may be determined according to a result of the clustering. The user propensity determining unit 112 may define a characteristic of each of the N groups according to the weight distribution of the plurality of user propensity factors for each group. When the user propensity determining unit 112 fails to accumulate response data for the user propensity test by a sufficient size/amount, the plurality of user propensity groups may be derived by using data accumulated in another external database.

Alternatively, the user propensity determining unit 112 may define the user propensity by analyzing the response to the user propensity test and combining the analyzed response as the characteristic for each of the plurality of user propensity factors. The user propensity determining unit 112 may add up the result of multiplying the response to each of the plurality of questions constituting the user propensity test and the sensitivity of each question for each of the plurality of user propensity factors. The user propensity determining unit 112 may determine the user propensity based on the summation result for each of the plurality of user propensity factors. The user propensity determining unit 112 may define a characteristic of each user according to the weight distribution of the plurality of user propensity factors based on the response to the user propensity test for each of the plurality of users.

The user propensity determining unit 112 may transmit data representing the user propensity to the optimal vehicle determining unit 116 and the option group matching unit 115.

The vehicle propensity calculating unit 113 may calculate a vehicle propensity (hereinafter, a plurality of vehicle propensities) representing vehicle-specific characteristics for each of the plurality of vehicles from official data, own data, qualitative data, and the like (S4). The vehicle propensity may be determined by a plurality of vehicle propensity factors. The plurality of vehicle propensity factors may include factors corresponding to the plurality of user propensity factors. Official data may be data based on Consumer Report (CR/USA), AutoBilt (Europe), MotorTrend (USA), IIHS, KNCAP, EuroNCAP, Ministry of Land, Infrastructure and Transport, Ministry of Environment, Ministry of Industry, Insurance Development Institute, JD Power (USA), IF (Europe), IDEA (USA), and vehicle specifications. Own data may be data in which a person who provides a vehicle purchase information service based on the official data associates official data on a vehicle with the plurality of user propensity factors. Qualitative data may be values for the plurality of vehicle propensity factor items for a vehicle. The vehicle propensity calculating unit 113 may transmit data representing the plurality of vehicle propensities to the optimal vehicle determining unit 116 and the option group matching unit 115.

The vehicle propensity calculating unit 113 may include a plurality of weights for a plurality of vehicle propensity factors based on data for each of the plurality of vehicles (hereinafter, vehicle data) and evaluation data for each of the plurality of vehicles (hereinafter, vehicle evaluation data), and determine the vehicle propensity based on the plurality of calculated weights. The vehicle data may include data regarding vehicle specifications, price, color, performance, and maintenance cost. Vehicle evaluation data may include evaluation data for each vehicle provided by a vehicle evaluation institution and evaluation data collected by the service providing server 11 from users. The plurality of vehicle data and vehicle evaluation data may be stored in the database of the service providing server 11. The service providing server 11 may accumulate the plurality of vehicle data and the plurality of vehicle evaluation data, classify the plurality of vehicle data and the plurality of vehicle evaluation data for each vehicle, and store the classified plurality of vehicle data and plurality of vehicle evaluation data in the database. The service providing server 11 may collect information on vehicle data provided by a vehicle manufacturer, classify the collected information for each vehicle, and store the classified information in the database. The service providing server 11 may request and collect vehicle evaluation data from a server of the evaluation institution, classify the collected vehicle evaluation data for each vehicle, and store the classified data in the database.

The vehicle propensity calculating unit 113 may calculate weights for the plurality of vehicle propensity factors based on the vehicle data and the vehicle evaluation data. The plurality of vehicle propensity factors are factors corresponding to the plurality of user propensity factors. In an embodiment, the plurality of vehicle propensity factors and the plurality of user propensity factors are the same. However, the disclosure is not limited thereto. Although there is a correspondence relationship between the plurality of vehicle propensity factors and the plurality of user propensity factors, the plurality of vehicle propensity factors and the plurality of user propensity factors may not be the same.

The vehicle propensity calculating unit 113 may determine a weight for economic feasibility, which is one of the vehicle propensity factors, based on the price of the vehicle and the maintenance cost for a predetermined period in the vehicle data.

The vehicle propensity calculating unit 113 may determine a weight for safety, which is one of the vehicle propensity factors, based on official data among the vehicle evaluation data and data related to safety matters among the vehicle data. Safety-related official data are collected from Insurance Institute for Highway Safety (IIHS, USA), Korean New Car Assessment Program (KNCAP, Korea), European New Car Assessment Program (EuroNCAP, Europe), Ministry of Land, Infrastructure and Transport, Ministry of Environment, Ministry of Industry, Insurance Development Institute, and the like.

The vehicle propensity calculating unit 113 may determine a weight for self-consciousness, which is one of the vehicle propensity factors, by using the vehicle evaluation data. Official data related to self-consciousness may be collected from consumer report (CR, USA), AutoBilt (Europe), MotorTrend (USA), and the like, or may be collected from the results of a survey on the brand value of vehicle manufacturers.

The vehicle propensity calculating unit 113 may determine a weight for technology, which is one of the vehicle propensity factors, based on a new technology newly applied to the vehicle among the vehicle data. For example, the technology weight of a vehicle to which autonomous driving, a hydrogen car, an electric vehicle, a new collision avoidance system, and the like is applied may be high when compared to a threshold value.

The vehicle propensity calculating unit 113 may determine a weight for reliability, which is one of the vehicle propensity factors, based on the vehicle evaluation data. Reliability-related official data may include JD Power (USA)'s new car quality index data, internal quality index data, and the like.

The vehicle propensity calculating unit 113 may determine a weight for a function, which is one of the vehicle propensity factors, based on the vehicle data. The function-related vehicle data may include data related to vehicle weight, performance of a vehicle engine, performance of a vehicle motor, and the like.

The vehicle propensity calculating unit 113 may determine a weight for aesthetics, which is one of the vehicle propensity factors, based on the vehicle evaluation data. Official data related to aesthetics may be collected from International Forum (IF, Europe), International Design Excellence Award (IDEA, USA), and the like.

The above description provides various examples according to various embodiments and the disclosure is not limited thereto. The vehicle propensity calculating unit 113 may use at least one of the vehicle data and the vehicle evaluation data when determining the vehicle propensity factor, and the present disclosure is not limited by the disclosed examples. For example, the weight for the vehicle propensity factor may be determined by using the data accumulated by the vehicle matching system 1 together with or instead of the official data.

The option group classifying unit 114 may set a plurality of option groups for each of the plurality of vehicles according to a trim and an option specification of each vehicle (S5). The plurality of option groups may include a cost effectiveness option group that prioritizes a low trim, i.e., a low trim level relative to a base model level (e.g., less features), and few option specifications; a safe option group that prioritizes the trims and option specifications related to the vehicle's defense function against external dangers or accidents, a new technology option group that prioritizes trim and option specifications related to new technology applied to the vehicle, and a dress-up option group that prioritizes high trim, i.e., a high trim level relative to a base model level (e.g., more features), and option specifications related to a higher aesthetic appearance value than the foregoing groups. However, the plurality of option groups is not limited to those listed above. Various factors that may be considered in determining the option group may be further considered in determining the option group.

The option group classifying unit 114 may determine trim and option specifications corresponding to each of the cost-effectiveness option group, the safety option group, the new technology option group, and the dress-up option group. The option group classifying unit 114 may create a plurality of option groups by grouping option specifications among the plurality of specifications belonging to each of the plurality of vehicles. The option group classifying unit 114 may classify the plurality of vehicles into a plurality of option groups and store the classified option groups in the database. For example, the cost-effectiveness option group may include only the lowest trim, i.e., the lowest trim level relative to base model levels/features, among the plurality of trims belonging to one vehicle and only the basic necessary option specifications, and the dress-up option group may include the highest trim, i.e., the highest trim level related to additional features relative to the base model level/features, among the plurality of trims belonging to one vehicle, and optional specifications, such as a panoramic sunroof and 17-inch wheels. Hereinafter, for convenience of description, it may be assumed that the plurality of option groups includes the cost-effectiveness option group, the safety option group, the new technology option group, and the dress-up option group.

The service providing server 11 may generate data representing the plurality of vehicle propensities and data representing the plurality of option groups for each of the plurality of vehicles. The service providing server 11 may store the generated data representing the plurality of vehicle propensities and the plurality of option groups generated for each of the plurality of vehicles in the database. The service providing server 11 may proceed to operations S6 to S8 based on the stored data representing the plurality of vehicle propensities and the plurality of option groups instead of operations S4 and S5.

The option group matching unit 115 may determine a target option group matching the user from among the plurality of option groups based on the user propensity, the plurality of vehicle propensities, and the data representing the plurality of option groups (S6).

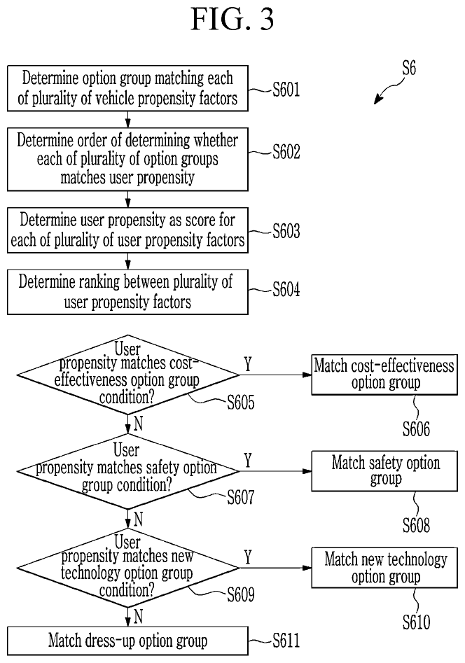

The detailed sequence of operation S6 is described below with reference to FIG. 3.

FIG. 3 is a detailed flowchart of operation S6 of FIG. 2.

The option group matching unit 115 may determine an option group matching each of the plurality of vehicle propensity factors (S601). For example, the option group classifying unit 114 may classify a vehicle propensity factor matching each of the cost-effectiveness option group, the safety option group, the new technology option group, and the dress-up option group among the plurality of vehicle propensity factors.

The option group matching unit 115 may classify the plurality of vehicle propensity factors into a vehicle selection priority item that is preferentially considered for vehicle selection and an option group priority item that is an item preferentially considered for option group selection within one vehicle.

For example, each of the self-consciousness, reliability, and functionality factors among the plurality of vehicle propensity factors may be classified as the vehicle selection priority item. In particular, each of the self-consciousness and functionality factors may indicate the degree to which a higher-level vehicle is preferred rather than optional specifications or trim. The higher-level vehicle may be a higher price model relative to a base model level (e.g., greater engine displacement). Further, the reliability factor is the degree to which a higher-level vehicle with fewer option specifications is preferred to a lower-level vehicle with many option specifications at the same price in order to lower the probability of failure. The lower-level vehicle may be a lower price model relative to a base model level (e.g., lower engine displacement). In addition, among the plurality of vehicle propensity factors, economic feasibility, safety, technology, and aesthetics may be classified as the option group priority items. Economic feasibility may be used for matching with the cost-effectiveness option group, safety may be used for matching with the safety option group, technology may be used for matching with the new technology option group, and aesthetics may be used for matching with the dress-up option group.

Since the vehicle selection priority item is an item that is preferentially considered in selecting a higher-level vehicle, the vehicle selection priority item may be matching the cost-effectiveness option group, which is the option group with low trim and few option specifications among the same vehicles. Therefore, economic feasibility, self-consciousness, reliability, and functionality factors may be used for matching with the cost-effectiveness option group.

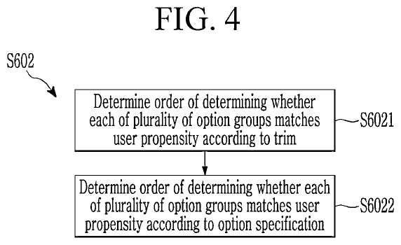

The option group matching unit 115 may determine the order/rank for determining whether each of the plurality of option groups and the user propensity match, in order to determine the user propensity and the target option group among the plurality of option groups (S602). The option group matching unit 115 may determine a determination order/rank between operations S605, S607, and S609 according to the determination order/rank of the option group determined in operation S602. A detailed sequence of operations S602 is described below with reference to FIG. 4.

FIG. 4 is a detailed flowchart of operation S602 of FIG. 3.

The option group matching unit 115 may determine the order of determining whether each of the plurality of option groups matches the user propensity according to the trim (S6021). The option group matching unit 115 may determine a determination order among the plurality of option groups according to the trim belonging to the vehicle. For example, the option group matching unit 115 may determine that, among the plurality of option groups with different trims, each of the corresponding option groups with the lower trim is assigned a first or higher level order/rank of determination. In operation S6021, in another example, the order of determination for the plurality of option groups of the same trim may be the same.

The option group matching unit 115 may determine an order of determining whether each of a plurality of option groups of the same trim matches the user propensity according to the option specification (S6022). The option group matching unit 115 may determine the order of determination among the plurality of option groups according to the number of option specifications belonging to the vehicle. For example, the option group matching unit 115 may determine that, among the plurality of option groups of the same trim, the corresponding option groups with the smaller number of option specifications (relative to other option groups), are assigned a first or higher level order/rank of determination.

Referring back to FIG. 3, the option group matching unit 115 may determine a user propensity as a score for each of a plurality of user propensity factors (S603). For example, the option group matching unit 115 may convert user A's propensity into a score for each item of economic feasibility, safety, self-consciousness, technicality, reliability, functionality, and aesthetics.

The option group matching unit 115 may determine the rank of the plurality of user propensity factors according to the score for each of the plurality of user propensity factors (S604). The option group matching unit 115 may determine the ranking of the plurality of user propensity factors in the order of the highest score for each of the plurality of user propensity factors. The option group matching unit 115 may determine that the higher the ranking of the plurality of user propensity factors is, the higher the weight of the user propensity is.

In one embodiment, the steps S605, S607, and S609 are performed assuming that the order of determination of the option group determined in operation S602 is the cost-effectiveness option group, the safety option group, the new technology option group, and the dress-up option group. However, the disclosure is not limited to this embodiment.

The option group matching unit 115 may determine whether the user propensity meets the cost-effectiveness option group condition (S605). The cost-effectiveness option group condition may include a condition in which a predetermined number of propensity factors with the prior ranking among the plurality of user propensity factors are the factors matching the cost-effectiveness option group, and a condition in which the difference in score between the factors matching the cost-effectiveness option group and another factor is equal to or greater than or equal to a threshold value. For example, when the factors within the second place among the plurality of user propensity factors are economic feasibility and reliability, each of the economic feasibility and reliability are the factors matching the cost-effectiveness option group. Therefore, the option group matching unit 115 determines that the user propensity satisfies one of the factors of the cost-effectiveness option group. In addition, when a predetermined ratio γ of the highest score α among the scores of the factors matching the cost-effectiveness option group is greater than the highest score β among the scores for the respective remaining propensity factors (for example, safety, technology, and aesthetics) not including the factors (for example, economic feasibility, self-consciousness, reliablity, and functionality) matching the cost-effectiveness option group among the plurality of user propensity factors (β<α*γ), the option group matching unit 115 may determine that the difference in score between the factor matching the cost-effectiveness option group and another factor is equal to or greater than a threshold. For example, when the highest score α among the scores of the factors matching the cost-effectiveness option group is 5, the predetermined ratio γ is 75%, and the highest score β among the scores of the remaining factors not including the factors matching the cost-effectiveness option group among the plurality of user propensity factors is 3.5, β<α*γ, so that the option group matching unit 115 may determine that the difference in score between the factors matching the cost-effectiveness option group and another factor is equal to or greater than the threshold value.

When the user propensity meets the cost-effectiveness option group condition in operation S605, the option group matching unit 115 may determine that the cost-effectiveness option group matches the user (S606). The option group matching unit 115 may determine the cost-effectiveness option group as the target option group.

When the user propensity does not meet the cost-effectiveness option group condition in operation S605, the option group matching unit 115 may determine whether the user propensity meets the safety option group condition (S607). The safety option group condition may include a condition in which, among the plurality of user propensity factors, a predetermined number of propensity factors, in which the ranking of the remaining user propensity factors not including the factors matching the cost-effectiveness option group includes the prior ranking, are the factors matching the safety option group, and a condition that a difference in score between the factor matching the safety option group and another factor are equal to or greater than a threshold value. For example, when the first factor among the plurality of propensity factors excluding the factor matching the cost-effectiveness option group is safety, i.e., when safety is the factor matching the safety option group, the option group matching unit 115 determines that the user propensity satisfies one of the factors of the safety option group. In addition, when a predetermined ratio ζ of the highest score δ among the scores of the factor (for example, safety) matching the safety option group is greater than the highest score ε among the scores for each of the remaining factors (for example, technology and aesthetics) excluding the factor matching the cost-effectiveness option group and the factor matching the safety option group among the plurality of user propensity factors (ε<δ*ζ), the option group matching unit 115 may determine that the difference in score between the factor matching the safety option group and another factor is equal to or greater than a threshold value.

For example, the highest score δ among the scores of the factors matching the safety option group is 3.8, the predetermined ratio ζ is 75%, and the highest score ε among the scores of the remaining factors not including the factor matching the cost-effectiveness option group and the factor matching the safety option group among a plurality of user propensity factors is 2.7, ε<δ*ζ, so that the option group matching unit 115 may determine that the difference in score between the factor matching the safety option group and another factor is equal to or greater than a threshold value.

When the user propensity meets the safety option group condition in operation S607, the option group matching unit 115 may determine that the safety option group matches the user (S608). The option group matching unit 115 may determine the safety option group as the target option group.

When the user propensity does not meet the safety option group condition in operation S607, the option group matching unit 115 may determine whether the user propensity meets the new technology option group condition (S609). The new technology option group condition may include a condition that a score η of a factor matching the new technology option group is greater than a score θ of the factor matching the dress-up option group. For example, when the score η of the factor matching the new technology option group is 2.7 and the score θ of the factor matching the dress-up option group is 1, η>θ, the option group matching unit 115 may determine that the user propensity meets the new technology option group condition.

When the user propensity meets the new technology option group condition in step S609, the option group matching unit 115 may determine that the new technology option group matches the user (S610). The option group matching unit 115 may determine the new technology option group as the target option group.

If the user propensity does not meet the new technology option group condition in operation S609, the option group matching unit 115 may determine that the dress-up option group matches the user (S611). The option group matching unit 115 may determine the dress-up option group as the target option group.

The optimal vehicle determining unit 116 may determine the plurality of target vehicles according to a user's vehicle purchase budget range among the plurality of vehicles corresponding to the target option group based on the user information, the user propensity, the vehicle propensity for the plurality of vehicles, and the target option group, and determine an optimal vehicle (e.g., at least one optimal vehicle) among the plurality of target vehicles (S7). The optimal vehicle determining unit 116 may determine a plurality of target vehicles from among the vehicles corresponding to the target option group for each of the plurality of vehicles. When the optimal vehicle determining unit 116 determines the plurality of target vehicles, the user's vehicle purchase budget range and the like may be considered. The optimal vehicle determining unit 116 may calculate the degree of matching of each of the plurality of target vehicles according to a result of comparing the vehicle propensity of each of the plurality of target vehicles with the user propensity. The optimal vehicle determining unit 116 may rank the matching order in the order of the degree of matching. The optimal vehicle determining unit 116 may determine an optimal vehicle from the plurality of target vehicles according to the matching order of the plurality of target vehicles.

The optimal vehicle determining unit 116 may calculate a degree of matching of each of the plurality of target vehicles by using at least one of a standard deviation method, a factoring method, and a hybrid method based on the data representing the user propensity and the vehicle propensity. The optimal vehicle determining unit 116 may use at least one of a standard deviation method, a factoring method, and a hybrid method for quantifying the degree of matching between the vehicle propensity and the user propensity.

For example, when the optimal vehicle determining unit 116 uses the standard deviation method, it is possible to calculate a difference between the weight of each user propensity factor and the weight of each corresponding vehicle propensity factor. The optimal vehicle determining unit 116 may calculate a degree of matching according to a result of adding up differences calculated through the standard deviation method for the plurality of user propensity factors and the plurality of vehicle propensity factors for each of the plurality of target vehicles. The optimal vehicle determining unit 116 may determine that the degree of matching is larger (i.e., increases) as the result of adding up the differences calculated through the standard deviation method is smaller.

Alternatively, when the optimal vehicle determining unit 116 uses the factoring method, a product between the weight of each user propensity factor and the corresponding weight of each vehicle propensity factor may be calculated. The optimal vehicle determining unit 116 may calculate a degree of matching according to a result of adding up products calculated through the factoring method for the plurality of user propensity factors and the plurality of vehicle propensity factors for each of the plurality of target vehicles. In an embodiment, the optimal vehicle determining unit 116 may determine that the degree of matching is greater (e.g., increases) as the result of adding up the products calculated through the factoring method is greater. In other words, the degree of matching increases as the results increase.

Alternatively, when the optimal vehicle determining unit 116 uses the hybrid method, the optimal vehicle determining unit 116 may derive a candidate vehicle from among a plurality of target vehicles according to the factoring method and determine the matching order by applying the standard deviation method to the candidate vehicle. For example, the optimal vehicle determining unit 116 may derive a predetermined number of higher-level vehicles among the sum of the totals of the plurality of vehicle propensity factors for each of the plurality of vehicles derived according to the factoring method for each of the plurality of target vehicles as a candidate vehicle. The optimal vehicle determining unit 116 may rank the matching order for the candidate vehicles in the order of smallest standard deviation to highest standard deviation according to the standard deviation method.

As described above, the optimal vehicle determining unit 116 may determine the matching order differently according to the standard deviation method, the factoring method, and the hybrid method. The determination of one of the standard deviation method, the factoring method, and the hybrid method by the optimal vehicle determining unit 116 may be based on a user input via the user terminal 12. Additionally, the method of determining the matching order by using the standard deviation method, the factoring method, and the hybrid method is not limited.

The optimal vehicle determining unit 116 may determine at least one vehicle whose matching order belonging to a predetermined range among the plurality of target vehicles as an optimal vehicle. For example, when the matching option group is the cost-effectiveness option group, the optimal vehicle determining unit 116 may determine three vehicles corresponding to the top three matching order among the plurality of target vehicles corresponding to the cost-effectiveness option group as the optimal vehicles (i.e., the at least one optimal vehicle).

Referring to FIG. 2, the service providing server 11 may provide the user with a vehicle purchase information service for the at least one optimal vehicle through the user terminal 12 (S8). The service providing server 11 may transmit data indicating the at least one optimal vehicle to the user terminal 12. The data indicating the at least one optimal vehicle may include data indicating the type of vehicle of the at least one optimal vehicle, a power train, and an option group. When the user terminal 12 receives the data indicating the at least one optimal vehicle, the application 121 may provide a screen displaying the at least one optimal vehicle to the user through the user terminal 12.

While this disclosure has been described in connection with what is considered to be various embodiments, it should be understood that the disclosure is not limited to the disclosed embodiments.

### DESCRIPTION OF SYMBOLS

1: Vehicle matching system
11: Service providing server
111: Collecting unit
112: User propensity determining unit
113: Vehicle propensity calculating unit
114: Option group classifying unit
115: Option group matching unit
116: Optimal vehicle determining unit
12: User terminal
121: Application

What is claimed is:

1. A vehicle matching method performed by a service providing server, the vehicle matching method comprising:
providing a user question and a user propensity test to an application via a user terminal;
receiving responses to the user question and the user propensity test from the user terminal and determining a user propensity based on the responses;
calculating a plurality of vehicle propensities representing vehicle-specific characteristics for each of a plurality of vehicles;
setting a plurality of option groups for each of the plurality of vehicles according to trim and option specifications of each vehicle;
matching one option group among the plurality of option groups to the user based on the user propensity;
determining a degree of matching between a vehicle propensity of each of a plurality of target vehicles belonging to a vehicle purchase budget range among the plurality of vehicles corresponding to the one option group and the user propensity; and
determining at least one optimal vehicle among the plurality of target vehicles based on the degree of matching with the plurality of target vehicles.

2. The vehicle matching method of claim 1, wherein the matching further includes:
determining an option group that matches each of a plurality of vehicle propensity factors for each of the plurality of vehicles;
determining an order of determining whether each of the plurality of option groups matches the user propensity;
determining the user propensity as a score for each of a plurality of user propensity factors; and
determining a ranking between the plurality of user propensity factors based on the score for each of the plurality of user propensity factors.

3. The vehicle matching method of claim 2, further comprising:
when a first ranking in an order of determining whether each of the plurality of option groups matches the user propensity is a first option group and the user propensity meets a condition of the first option group, matching the first option group to the user,
wherein the condition of the first option group includes a condition in which a predetermined number of propensity factors having a prior ranking among the rankings of the plurality of user propensity factors are factors matching the first option group and a difference in score between the factors matching the first option group and another factor is equal to or greater than a threshold value.

4. The vehicle matching method of claim 3, further comprising:
when a second ranking in the order of determining whether each of the plurality of option groups matches the user propensity is a second option group, the user propensity does not meet the condition of the first option group, and the user propensity meets a condition of the second option group, matching the second option group to the user,
wherein the condition of the second option group includes a condition in which a predetermined number of remaining propensity factors, not including the factors matching the first option group among the plurality of user propensity factors, having the prior ranking is the factors matching the second option group and a difference in score between the factors matching the second option group and the remaining propensity factors is equal to or greater than a threshold value.

5. The vehicle matching method of claim 4, further comprising:
when a third ranking in the order of determining whether each of the plurality of option groups and the user propensity match is a third option group, a fourth ranking is a fourth option group, the user propensity does not meet the conditions of the first and second option groups, and a score of the factor matching the third option group among the plurality of user propensity factors is higher than a score matching the fourth option group, matching the third option group to the user.

6. The vehicle matching method of claim 1, wherein the determining of at least one optimal vehicle includes:
determining a predetermined number of vehicles having a prior ranking in an order of increasing the degree of matching among the plurality of target vehicles as the at least one optimal vehicle.

7. A service providing server including a processor coupled with a non-transitory memory storing program code, the service providing server comprising:
a collecting unit for collecting user information that is a response to a user question and a response to a user propensity test from a user terminal;
a user propensity determining unit for determining a user propensity based on the user information and the response to the user propensity test;
a vehicle propensity calculating unit for calculating a plurality of vehicle propensities representing vehicle-specific characteristics for each of a plurality of vehicles;
an option group classifying unit for setting a plurality of option groups for each of the plurality of vehicles according to trim and option specifications of each vehicle;
an option group matching unit for determining a target option group to match a user based on the user propensities and the plurality of vehicle propensities among the plurality of option group; and
an optimal vehicle determining unit for determining a plurality of target vehicles corresponding to the target option group among the plurality of vehicles and corresponding to a vehicle purchase budget range of the user, and determining at least one optimal vehicle among the plurality of target vehicles according to a degree of matching in which each of the plurality of target vehicles matches the user propensity.

8. The service providing server of claim 7, wherein the option group matching unit determines an option group matching each of a plurality of vehicle propensity factors for each of the plurality of vehicles among the plurality of option groups, determines an order between the plurality of option groups, determines the user propensity as a score for each of a plurality of user propensity factors, and determines a ranking between the plurality of user propensity factors based on the score for each of the plurality of user propensity factors.

9. The service providing server of claim 8, wherein when a first ranking in the order between the option groups is a first option group, a predetermined number of propensity factors having a prior ranking among the plurality of user propensity factors are factors matching the first option group, and a difference in a score between the factors matching the first option group and another factor is equal to or greater than a threshold value, the option group matching unit matches the first option group to the user.

10. The service providing server of claim 9, wherein when a second ranking in the order between the option groups is a second option group, the user does not match the first option group among the plurality of user propensity factors, a predetermined number of remaining propensity factors, not including the factors matching the first option group among the plurality of user propensity factors, having the prior ranking is the factors matching the second option group, and when a difference in score between the factor matching the second option group and the remaining propensity factors is equal to or greater than a threshold value, the option group matching unit matches the second option group to the user.

11. The service providing server of claim 10, wherein when a third ranking in the order between the option groups is a third option group and a fourth ranking is a fourth option group, the first or second option group does not match the user, and a score of a factor matching the third option group among the plurality of user propensity factors is higher than a score matching the fourth option group, the option group matching unit matches the third option group to the user.

12. The service providing server of claim 7, wherein the optimal vehicle determining unit calculates the degree of matching according to a result of comparing the user propensity with the plurality of vehicle propensities for each of the plurality of target vehicles, assigns a matching order to each of the plurality of target vehicles in an order of increasing the degree of matching, and determines a predetermined number of vehicles with a prior ranking as the at least one optimal vehicle according to the matching order.
